(19) United States
(12) Patent Application Publication
(10) Pub. No.: US 2024/0383733 A1
(43) Pub. Date: Nov. 21, 2024

(54) HANDLING MACHINE

(71) Applicant: MANITOU BF, ANCENIS (FR)

(72) Inventor: Guillaume GABILLARD, ANCENIS (FR)

(21) Appl. No.: 18/696,576

(22) PCT Filed: Aug. 30, 2022
(86) PCT No.: PCT/FR2022/051626

§ 371 Date: Mar. 28, 2024

(30) Foreign Application Priority Data
Sep. 29, 2021 (FR) 2110245

(51) Int. Cl. B66F 9/24; B66F 9/075; E02F 3/96; E02F 9/20

(52) U.S. Cl. CPC B66F 9/24; B66F 9/07581; E02F 3/96; E02F 9/205

(57) ABSTRACT

A handling machine (1) comprising: —a wheeled chassis (2), —a system (3) for handling a load and/or a person, —a control console (5) for controlling the members (4) for driving on the ground and for controlling the handling system (3) of the machine (1), —a control unit (6). The control console (5) has at least three selectively activatable use configurations. The first and second use configurations are use configurations in which the control console (5) is carried directly or indirectly by the chassis (2) of the machine (1). The third use configuration is a configuration in which the control console (5) is able to operate away from the chassis (2) and from the handling system (3) of the machine (1). The control unit (6) comprises a system (7) for determining the use configuration of the control console (5) and is configured to control the machine (1) according to the determined use configuration.

The present invention relates to a handling machine.

In particular, it relates to a handling machine comprising a chassis,
a system for handling a load and/or a person carried by the chassis,
a members for driving the machine on the ground,
a control console configured for controlling at least the members for driving on the ground and the handling system of the machine, and
a control unit configured for acquiring data from the control console and for controlling at least the system for handling a load and/or a person and/or the members for driving the machine on the ground, on the basis of said data at least.

Such a handling machine is well known to those skilled in the art. The manufacturers of such machines are seeking constructive solutions allowing multi-purpose use of the machine without detracting from the simplicity of manufacture of the machine.

One object of the invention is to propose a handling machine of the aforesaid type whose design allows multi-purpose use of the machine without detracting from the simplicity of manufacture of the machine.

To this end, the invention proposes a handling machine comprising:
a chassis,
a system for handling a load and/or a person, carried by the chassis,
members for driving the machine on the ground,
a control console configured for controlling at least the members for driving on the ground and the handling system of the machine,
a control unit configured for acquiring data from the control console and for controlling at least the system for handling a load and/or a person and/or its members for driving the machine on the ground, according to said data at least, characterized in that the control console has at least three selectively activatable use configurations, in that the first and second use configurations are use configurations in which the control console is carried directly or indirectly by the chassis of the machine, in that the third use configuration is a configuration in which the control console is able to operate away from the chassis and from the handling system of the machine, in that the control unit comprises a system for determining the use configuration of the control console, and in that the control unit is configured for controlling the machine according to the determined use configuration.

By using the control console in at least three configurations, it is possible to simplify the manufacture of the machine by comparison with the prior art. Thus the presence of at least three use configurations enables the control console to be used in the driver's position of the machine as a replacement for a fixed control device permanently installed in the driver's position. The fixed control device installed in the driver's position can therefore be dispensed with. The presence of at least three use configurations enables the same control console to be used on a mobile platform such as a basket carried by the load and/or person handling system. Finally, the presence of at least three use configurations enables the same control console to be used remotely, that is to say at a distance from the chassis and from the handling system of the machine, in the same way as a remote controller, with an operator positioned at a distance from the chassis and from the handling system of the machine, that is to say beside the machine, for example.

According to one embodiment of the invention, the machine comprises a wired connection system between the control unit and the control console.

According to one embodiment of the invention, the wired connection system comprises a first wired link and a second wired link, and the system for determining the use configuration of the control console is configured to determine that the control console is in the first use configuration in the state of connection of the control console to the control unit via the first wired link and to determine that the control console is in the second use configuration in the state of connection of the control console to the control unit via the second wired link. This simplifies the determination of a use configuration. Preferably, the control console comprises the same connector for the connection of the first wired link and the second wired link to the control console, and the electrical characteristics of the connection formed by the connector and the wired link depend on the wired link by which the control console is connected to the control unit.

According to one embodiment of the invention, the machine comprises a system of connection by wireless communication between the control unit and the control console.

According to one embodiment of the invention, the system for determining the use configuration of the control console is configured to determine that the control console is in the third use configuration in the state of non-connection of the control console and the control unit by the wired connection system and/or in the state of establishment of wireless communication between the control console and the control unit. Once again, this design enables the active use configuration of the control console to be determined in a simple manner.

According to one embodiment of the invention, the handling system comprises at least one pivoting arm mounted pivotably about an axis called the horizontal axis, between a high position away from the ground and a low position close to the ground.

According to one embodiment of the invention, the control unit is configured to control the pivoting movement of the arm from the low position to the high position at a maximum speed of movement which depends on the use configuration of the control console. Thus, the maximum speed of movement of the arm varies according to whether the control console is in the driver's position, on a mobile platform such as a basket, or at a distance from the chassis and from the load and/or person handling system of the machine.

According to one embodiment of the invention, said machine comprises a driver's position carried at least partially by the chassis of the machine and a mobile platform that can be coupled to the handling system, the first use configuration of the control console is a configuration in which the control console is placed in the driver's position and the second use configuration is a configuration in which the control console is mounted on the mobile platform so that it can move integrally with said platform. This mobile platform usually takes the form of a basket, also called a work platform.

According to one embodiment of the invention, the mobile platform being an orientable platform mounted for what is known as right or left orientation by rotation about an axis orthogonal to the rotation axis of the arm, and the control console comprising at least one controller for the orientation of said platform, the control unit is configured so that, in the activated state of said controller, it controls the orientation of the platform in a direction of movement which depends on the use configuration of the control console. Thus the same command, using the same operator action at the control console, may, depending on the use configuration of the control console, generate a rightward movement of the platform in one use configuration and a leftward movement of the platform in another use configuration.

According to one embodiment of the invention, the control console comprises at least two controllers, such as pivoting levers, configured to control the handling system in one case, and the members for driving the machine on the ground in the other case.

According to one embodiment of the invention, the members for driving the machine on the ground are wheels including at least one steerable wheel, the controller of the members for driving the machine on the ground is a member for driving the steerable wheel or at least one of the steerable wheels in rotation and orientation, and the control unit is configured so that, in the activated state of said controller, it controls the rotation and/or orientation of the steerable wheel or at least one of the steerable wheels according to a direction of movement which depends on the use configuration of the control console. Once again, the same command, using the same operator action, that is to say the same movement, at the control console, may, depending on the use configuration of the control console, generate a rotation of the wheels in one direction in one use configuration, and a rotation of the wheels in an opposite direction in another use configuration.

According to one embodiment of the invention, in the first configuration in which the control console is placed in the driver's position, the control unit is configured so that, in the state where said controller of the orientation of the steerable wheel or at least one of the steerable wheels is actuated and then released, it controls an automatic return of the steerable wheel or at least one of the steerable wheels to what is known as a straight position, corresponding to a movement of the machine in a straight line.

According to one embodiment of the invention, the control unit is configured to control the machine at a maximum speed which depends on the use configuration of the control console. Thus the control unit automatically takes the use configuration of the control console into account. The maximum speed of movement of the machine varies according to whether the control console is in the driver's position, on a mobile platform such as a basket, or at a distance from the chassis and from the load and/or person handling system of the machine. This provides safe driving in all conditions.

According to one embodiment of the invention, the machine comprises a turret mounted rotatably on the chassis and the control console comprises at least one controller such as a pivoting lever for controlling the rotation of the turret. Preferably, this controller for controlling the rotation of the turret, and the controller for orientating the platform, if the latter is present, may consist of a common controller such as a pivoting lever.

According to one embodiment of the invention, the control unit is configured to allow or prevent the rotation of the turret, depending on the use configuration of the control console. The rotation of the turret may therefore be allowed or prevented according to whether the control console is in the driver's position, on a mobile platform such as a basket, or at a distance from the chassis and from the load and/or person handling system of the machine. Again, this provides safe driving in all conditions.

According to one embodiment of the invention, the control console comprises at least one power accumulator.

### BRIEF DESCRIPTION OF THE DRAWINGS

The invention will be clearly understood from a perusal of the following description of exemplary embodiments, provided with reference to the attached drawings, in which:

FIG. 1 shows a perspective view of a handling machine in the first use configuration of the control console;

FIG. 2 shows a perspective view of a handling machine in the second use configuration of the control console;

FIG. 3 shows a perspective view of a handling machine in the third use configuration of the control console;

FIG. 4 shows a schematic view of the various options for communication between the control unit and the control console;

FIG. 5 shows a top view of two machines, in the first and second configuration respectively, with the same movement of a controller on the control console, to illustrate the difference in operation.

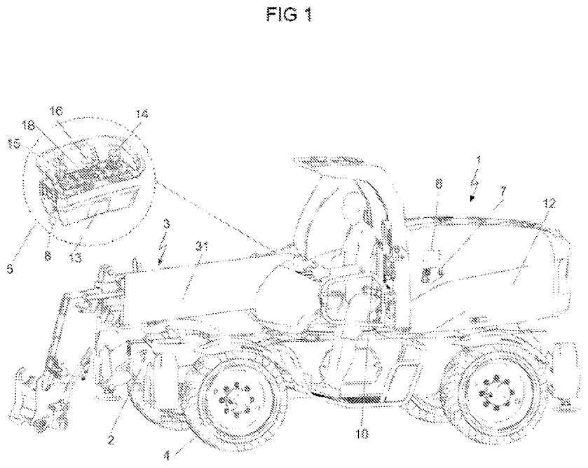

As mentioned above, the invention relates to a handling machine 1 such as that shown in FIG. 1.

In a known manner, this machine 1 comprises a chassis 2 equipped with members 4 for driving the machine on the ground, such as wheels or tracks. In the examples shown, the chassis 2 is a traveling chassis equipped with four wheels. At least two wheels of the machine are steerable wheels. Usually, the four wheels are driving wheels. In the example shown, the four wheels are steerable.

The machine 1 comprises a driver's position 10 carried at least partially by the chassis 2. This driver's position 10 comprises a seat which an operator may occur.

In the example shown, the machine 1 comprises a turret 12 mounted rotatably on the chassis 2 about an axis called the vertical axis, where the machine 1 is in the state of being positioned on a single horizontal plane.

The machine 1 further comprises a load and/or person handling system 3 carried by the chassis 2. The chassis 2 may carry the handling system 3 directly in the absence of a turret 12. When a turret 12 is present, the chassis may carry the load handling system 3 indirectly, that is to say via the turret 12.

This load handling system 3 usually comprises at least one pivoting arm 31 mounted pivotably about an axis called the horizontal axis, between a high position away from the ground and a low position close to the ground, where the machine is in the state of being positioned on a horizontal plane.

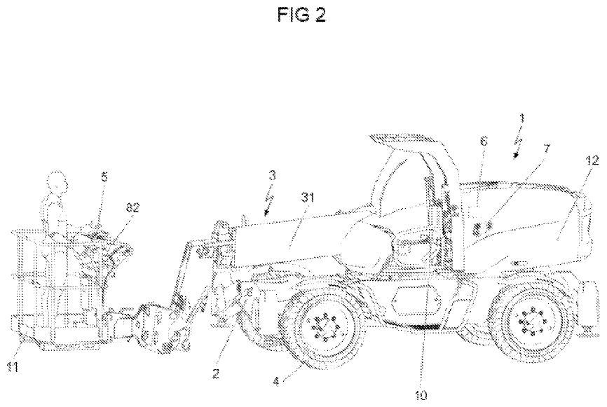

The free end of the arm 31 may be equipped with an accessory such as a fork or a bucket as shown in FIG. 1, or with a mobile platform 11 as shown in FIG. 2. This mobile platform 11, also called a basket, has a space to accommodate an operator who usually stands on the platform as shown in FIG. 2.

The machine 1 further comprises a control console 5 configured to control at least the members 4 for driving on the ground and the handling system 3 of the machine.

In the example shown, the control console 5 comprises two controllers, shown at 14 and 15 in the figures. These controllers are pivoting levers configured so that the one shown at 14 controls the handling system 3, while the other, shown at 15, controls the members 4 for driving the machine on the ground. On each occasion, the pivoting lever, also called a joystick, pivots in the forward and reverse direction and in the right and left direction. Additionally, the head of this lever is a rotating head for providing an additional control.

Thus the controller 15 for the members 4 for driving the machine on the ground enables the wheels of the machine to be driven in a first direction of movement, called the forward direction, and in a second, opposite, direction of movement called the reverse direction, by the forward and reverse pivoting movement of the controller, and enables the directional orientation of the machine to be changed by steering the wheels to the left or the right by a left or right pivoting movement of the controller.

The wheel orientation can also be controlled using the rotating part of the controller 15.

The controller 14 of the handling system 3 enables the arm to be raised or lowered by a forward/reverse pivoting movement of said controller 14, and enables an actuator, fitted on the end of the lifting arm and acting on the accessory, to be operated for the purpose of excavating with the bucket or emptying it, for example, by a left/right movement of said controller 14.

The rotating part of the controller 14 may be used to control telescopic closing or extension if the arm 31 is a telescopic arm.

In the example shown in FIG. 1, the control console 5 comprises another controller, shown at 16 in the figures. This controller 16 is a controller for the rotation of the turret 12. Here again, this controller 16 consists of a pivoting lever.

Additionally, in the example shown in FIG. 2, the mobile platform 11 is an orientable platform mounted for what is called its right/left orientation by rotation about an axis orthogonal to the axis of rotation of the arm 31, and the control console 5 comprises a controller 18 of the orientation of said platform.

In the examples shown, the controller 18 of the orientation of the mobile platform 11 and the controller 16 of the rotation of the turret 12 consist of a single pivoting lever mounted pivotably in the forward/reverse direction and in the left/right direction, the head of this lever being a rotating head.

The machine 1 further comprises a control unit configured to acquire data from the control console 5 and to control at least the load and/or person handling system 3 and the members 4 for driving the machine on the ground in accordance with said data at least.

Said control unit takes the form of an electronic data processing system comprising, for example, a microprocessor and a working store. According to a particular aspect, the control unit may take the form of a programmable logic controller. In other words, the functions and steps described may be executed in the form of a computer program or by means of hardware components (e.g. field programmable gate arrays). In particular, the functions and steps used by the control unit or its modules may be executed by sets of instructions or computer modules implemented in a processor or controller, or may be executed by dedicated electronic components or programmable logic circuit components or field-programmable gate arrays (FPGA) or application-specific integrated circuits (ASIC). It is also possible to combine software parts and electronic parts. When it is specified that the unit or means or modules of said unit are configured to execute a given operation, this means that the unit comprises computer instructions and the corresponding means of execution for the execution of said operation, and/or that the unit comprises corresponding electronic components.

In a manner which is characteristic of the invention, the control console 5 has at least three selectively activatable use configurations. The first and second use configurations are use configurations in which the control console 5 is carried directly or indirectly by the chassis 2 of the machine, and the third use configuration is a configuration in which the control console 5 can operate away from the chassis 2 and the handling system of the machine 3.

The control unit 6 comprises a system 7 for determining the use configuration of the control console 5 and the control unit 6 is configured for controlling the machine 1 according to the determined use configuration.

In particular, the first use configuration of the control console 5 is a configuration in which the control console 5 is placed in the driver's position 10. This first use configuration may be either a configuration in which the control console 5 is carried directly by the chassis or a configuration in which the control console 5 is, as illustrated in FIG. 1, integrated into a part of the driver's position carried by the turret, so that, in this case, the control console 5 is carried indirectly by the chassis 2. This first use configuration is shown in FIG. 1.

The second use configuration is a configuration in which the control console 5 is mounted on the mobile platform 11 so as to move integrally with said mobile platform 11. This second configuration is illustrated in FIG. 2.

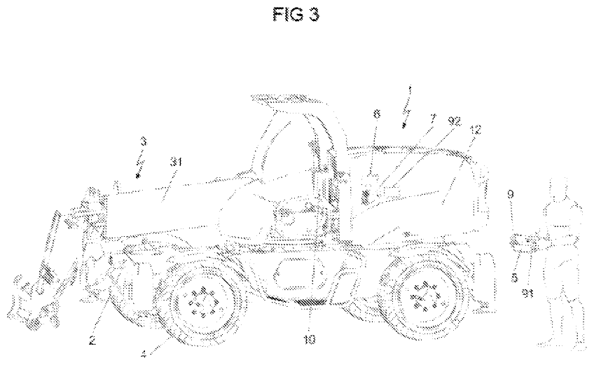

The third use configuration is a configuration in which the control console 5 is used as a remote controller by an operator positioned beside the machine, as illustrated in FIG. 3.

The control unit 6 comprises a system 7 for determining the use configuration of the control console 5, and the control unit 6 is configured for controlling the machine 1 according to the determined use configuration.

This system 7 for determining the use configuration may form an electronic or software module of the control unit 6.

The control console 5 comprises at least one power accumulator 13, such as a battery, for its operation.

The machine 1 further comprises a wired connection system 8 between the control unit 6 and the control console 5. This wired connection system 8 comprises a first wired link 81 and a second wired link 82.

The system 7 for determining the use configuration of the control console 5 is configured for determining whether the control console 5 is in the first use configuration in which the control console 5 is in a state of connection to the control unit via the first wired link 81. This determination system 7 is also configured for determining whether the control console 5 is in the second use configuration in which the control console 5 is in a state of connection to the control unit 6 via the second wired link 82.

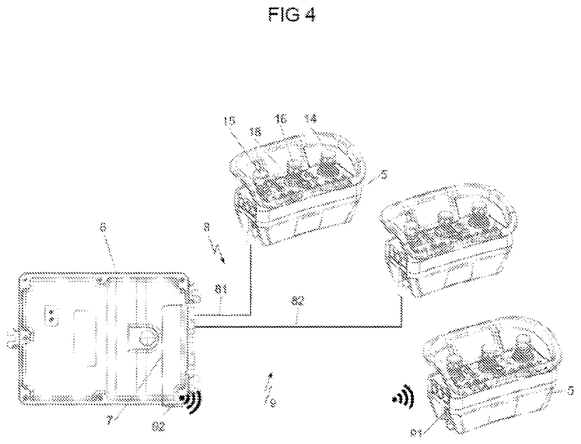

Thus, as illustrated in FIG. 4, the control console is equipped with a connector for connection via one or other of the wired links to the control unit 6 carried by the chassis 2.

The system 7 for determining the use configuration of the control console 5 is configured for detecting an electrical characteristic of the connection formed by the assembly consisting of the connector and the wired link.

Thus, for example, in the state in which the control console 5 is connected to the control unit 6 via the first wired link 81, the system 7 for determining the use configuration of the control console 5 is configured for detecting a 12 V voltage signal of said wired link. This determination system 7 is configured for detecting a ground signal in the state of connection of the control console 5 to the control unit 6 via the second wired link 82. Thus the wired link alone enables the control unit to know the use configuration of the control console 5.

In a first use configuration, the control console 5 is in the driver's position 10 and is connected via the first wired link 81 to the control unit 6. In a second use configuration, the control console 5 is in the mobile platform 11 and is connected via the second wired link 82 to the control unit 6.

The system 7 for determining the use configuration of the control console 5 may be configured for determining that, in the absence of a signal due to an absence of connection of the first and second wired links, the control console 5 is in the third use configuration.

In practice, the machine 1 comprises a wireless communication connection system 9 between the control unit 6 and the control console 5. This wireless communication connection system 9 may comprise a transceiver 91 fitted to the control console 5 and a transceiver 92 associated with the control unit 6.

As mentioned above, the system 7 for determining the use configuration of the control console 5 is configured for determining whether the control console 5 is in the third use configuration in the state of the control console 5 and the control unit 6 in which they are not connected via the first wired link 8.

In a variant, or additionally, the system 7 for determining the use configuration of the control console may be configured for determining whether the control console 5 is in the third use configuration in which a state of wireless communication is established between the control console 5 and the control unit 6.

In this third use configuration, the operator is usually positioned beside the chassis 2 of the machine 1, as illustrated in FIG. 3, and controls the machine remotely.

To summarize, the system 7 for determining the use configuration of the control console 5 is configured for determining the use configuration of the control console according to the mode of communication of the control console 5 with the control unit 6.

The control unit 6 is configured for controlling the machine 1 according to the use configuration determined by the system 7 for determining the use configuration.

Thus the machine 1 has operating modes that depend on the use configuration determine.

The control unit 6 may be configured to control the pivoting movement of the arm 31 from the low position to the high position at a maximum speed of movement which depends on the use configuration of the control console 5.

In practice, the maximum speed of upward and downward movement of the lifting arm 31 of the handling system 3 is higher in the first configuration than in the second and third configurations. This maximum speed is of the order of 1 m/s in the first and third configurations, while it is close to 0.4 m/s in the second use configuration.

The control unit 6 may be configured to control the machine 1 at a maximum speed which depends on the use configuration of the control console 5. Thus the maximum speed of the machine 1 is higher in the first configuration. By way of example, this maximum speed of movement of the machine is 15 km/h in the first configuration, 5 km/h in the second configuration and 3 km/h in the third configuration.

Similarly, the control unit 6 may be configured to allow or prevent the rotation of the turret 12, depending on the use configuration of the control console 5. Thus the rotation of the turret 12 is prevented in the first configuration of the control console 5.

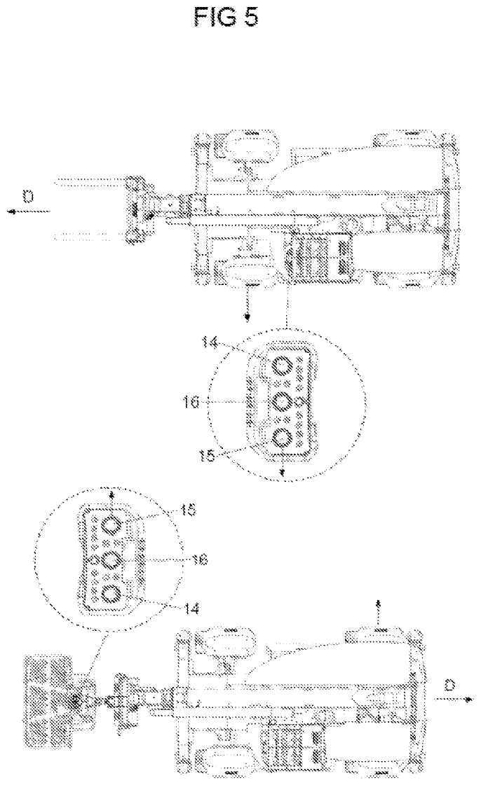

The control unit 6 may also be configured so that, in the actuated state of the controller 18 of the orientation of the mobile platform 11, it controls the orientation of the mobile platform 11 in a direction of movement which depends on the use configuration of the control console. These operating modes are illustrated in FIG. 5.

Thus, in the second use configuration of the control console, as illustrated in the upper diagram of FIG. 5 where the control console is on the mobile platform 11, the actuation of the controller 15 of the members 4 for driving the machine on the ground, namely the wheels, controls the orientation of the wheels closest to the pivoting link of the arm 31 to the chassis and controls the forward movement of the machine in the direction indicated by the arrow D.

Conversely, in the first use configuration of the control console, as illustrated in the lower diagram of FIG. 5 where the control console 5 is in the driver's position, the actuation of the controller 15 of the members 4 for driving the machine on the ground, namely the wheels, controls the orientation of the wheels farthest from the pivoting link of the arm 31 to the chassis, and controls the forward movement of the machine in the direction indicated by the arrow D.

It should be noted, therefore, that the control unit 6 is configured so that, in the actuated state of the controller 15 of the members 4 for driving the machine on the ground, it controls the rotation and/or the orientation of the steerable wheel, or at least one of the steerable wheels, in a direction of movement which depends on the use configuration of the control console.

Additionally, in the first configuration in which the control console 5 is placed in the driver's position 10, the control unit 6 is configured so that, in the state where the controller 15 of the orientation of the steerable wheel or at least one of the steerable wheels is actuated and then released, it controls an automatic return of the steerable wheel or at least one of the steerable wheels to what is known as a straight position, corresponding to a movement of the machine in a straight line.

1. A handling machine (1), comprising:
a chassis (2),
a system (3) for handling a load and/or a person, carried by the chassis (2),
members (4) for driving the machine on the ground,
a control console (5) configured for controlling at least the members (6) for driving on the ground and the handling system (3) of the machine (1), and
a control unit (6) configured for acquiring data from the control console (5) and for controlling at least the system (3) for handling a load and/or a person and/or its members (4) for driving the machine (1) on the ground, according to said data at least,
characterized in that the control console (5) has at least three selectively activatable use configurations, in that the first and second use configurations are use configurations in which the control console (5) is carried directly or indirectly by the chassis (2) of the machine (1), in that the third use configuration is a configuration in which the control console (5) is able to operate away from the chassis (2) and from the handling system (3) of the machine (1), in that the control unit (6) comprises a system (7) for determining the use configuration of the control console (5), and in that the control unit (6) is configured for controlling the machine (1) according to the determined use configuration.

2. The handling machine (1) as claimed in claim 1, characterized in that the machine (1) comprises a wireless communication connection system (8) between the control unit (6) and the control console (5).

3. The handling machine (1) as claimed in claim 2, characterized in that the wired connection system (8) comprises a first wired link (81) and a second wired link (82), the system (7) for determining the use configuration of the control console (5) is configured to determine that the control console (5) is in the first use configuration in the state of connection of the control console (5) to the control unit (6) via the first wired link (81) and to determine that the control console (5) is in the second use configuration in the state of connection of the control console (5) to the control unit (6) via the second wired link (82).

4. The handling machine (1) as claimed in any of claims 1 to 3, characterized in that the machine (1) comprises a wireless communication connection system (9) between the control unit (6) and the control console (5).

5. The handling machine (1) as claimed in claim 4, taken in combination with either of claims 2 and 3, characterized in that the system (7) for determining the use configuration of the control console (5) is configured to determine that the control console (5) is in the third use configuration in the state of non-connection of the control console (5) and the control unit (6) by the wired connection system (8) and/or in the state of establishment of wireless communication between the control console (5) and the control unit (6).

6. The handling machine (1) as claimed in any of claims 1 to 5, characterized in that the handling system (3) comprises at least one pivoting arm (31) mounted pivotably about an axis called the horizontal axis, between a high position away from the ground and a low position close to the ground.

7. The handling machine (1) as claimed in claim 6, characterized in that the control unit (6) is configured to control the pivoting movement of the arm (31) from the low position to the high position at a maximum speed of movement which depends on the use configuration of the control console (5).

8. The handling machine (1) as claimed in any of claims 1 to 7, characterized in that said machine (1) comprises a driver's position (10) carried at least partially by the chassis (2) of the machine (1) and a mobile platform (11) that can be coupled to the handling system (3), in that the first use configuration of the control console (5) is a configuration in which the control console (5) is placed in the driver's position (10), and in that the second use configuration is a configuration in which the control console (5) is mounted on the mobile platform (11) so that it can move integrally with said platform (11).

9. The handling machine (1) as claimed in claim 8, taken in combination with either of claims 6 and 7, characterized in that, the mobile platform (11) being an orientable platform mounted for what is known as right or left orientation by rotation about an axis orthogonal to the rotation axis of the arm (31), and the control console (5) comprising at least one controller (18) of the orientation of said platform (11), the control unit (6) is configured so that, in the activated state of said controller (18), it controls the orientation of the platform (11) in a direction of movement which depends on the use configuration of the control console (5).

10. The handling machine (1) as claimed in any of claims 1 to 9, characterized in that the control console (5) comprises at least two controllers (14, 15), such as pivoting levers (14, 15), of which one (14) is configured to control the handling system (3), and the other (15) is configured to control the members (4) for driving the machine (1) on the ground.

11. The handling machine (1) as claimed in claim 10, characterized in that the members (4) for driving the machine (1) on the ground are wheels including at least one steerable wheel, in that the controller (15) of the members (4) for driving the machine on the ground is a controller (15) for driving the steerable wheel or at least one of the steerable wheels in rotation and orientation, and in that the control unit (6) is configured so that, in the activated state of said controller (15), it controls the rotation and/or orientation of the steerable wheel or at least one of the steerable wheels according to a direction of movement which depends on the use configuration of the control console (5).

12. The handling machine (1) as claimed in claim 11, taken in combination with claim 8, characterized in that, in the first configuration in which the control console (5) is placed in the driver's position (10), the control unit (6) is configured so that, in the state where said controller (15) of the orientation of the steerable wheel or at least one of the steerable wheels is actuated and then released, it controls an automatic return of the steerable wheel or at least one of the steerable wheels to what is known as a straight position, corresponding to a movement of the machine (1) in a straight line.

13. The handling machine (1) as claimed in any of claims 1 to 12, characterized in that the control unit (6) is configured to control the machine (1) at a maximum speed which depends on the use configuration of the control console (5).

14. The handling machine (1) as claimed in any of claims 1 to 13, characterized in that the machine (1) comprises a turret (12) mounted rotatably on the chassis (2), and in that the control console (5) comprises at least one controller (16) such as a pivoting lever for controlling the rotation of the turret (12).

15. The handling machine (1) as claimed in claim 14, characterized in that the control unit (6) is configured to allow or prevent the rotation of the turret (12), depending on the use configuration of the control console (5).

16. The handling machine (1) as claimed in any of claims 1 to 15, characterized in that the control console (5) comprises at least one power accumulator (13).
